(19) United States
(12) Patent Application Publication
(10) Pub. No.: US 2025/0157093 A1
(43) Pub. Date: May 15, 2025

(54) Visual Object Consistency in Image Generation Models

(71) Applicant: Google LLC, Mountain View, CA (US)

(72) Inventors: Shlomo Fruchter, Ness Ziona (IL); Omri Avrahami, Jerusalem (IL); Daniel Cohen-Or, Hod HaSharon (IL); Daniel Lischinski, Jerusalem (IL); Amir Hertz, Tel Aviv (IL)

(21) Appl. No.: 18/949,681

(22) Filed: Nov. 15, 2024

Related U.S. Application Data
(60) Provisional application No. 63/599,496, filed on Nov. 15, 2023.

(51) Int. Cl. G06T 11/00; G06F 40/284; G06N 20/00

(52) U.S. Cl. CPC G06T 11/00; G06F 40/284; G06N 20/00

(57) ABSTRACT

Provided are systems and methods for generating self-consistent synthetic imagery based on a textual prompt. The proposed approaches address the challenge of producing consistent character images across different contexts, which is a common limitation of existing text-to-image generative models. The proposed approaches can be beneficial in various creative fields such as book illustration, brand crafting, comic creation, presentation development, and webpage design, where visual consistency is crucial.

### RELATED APPLICATIONS

This application claims priority to and the benefit of U.S. Provisional Patent Application No. 63/599,496, filed Nov. 15, 2023. U.S. Provisional Patent Application No. 63/599,496 is hereby incorporated by reference in its entirety.

### FIELD

The present disclosure relates generally to machine learning. More particularly, the present disclosure relates to techniques that enable text-to-image generation models to generate images that depict a visual object with consistent appearance.

### BACKGROUND

The field of generative models, particularly those that convert textual prompts into visual imagery, has seen significant advancements with recent breakthroughs in machine learning and artificial intelligence. Despite these advancements, generating consistent imagery that accurately represents a textual prompt remains a substantial challenge.

Existing methods for generating synthetic imagery from textual prompts often rely on multiple pre-existing images of the target character or other visual object. These models use these multiple images as reference points to generate new images. However, this approach presents several problems. First, it requires the existence of multiple pre-existing images, which may not always be available, particularly for novel or imaginary characters or objects. Second, these models often struggle with maintaining a consistent identity for the character or object across different images.

In addition to the above, the current methods involve labor-intensive manual processes and do not generalize well to new characters or objects. They are often trained on specific datasets and may not perform well when tasked with generating images of characters or objects not represented in the training data. This limitation significantly curtails the versatility and applicability of these models.

Due to the inconsistency in the synthetic images generated by existing models, users often need to perform multiple redundant model executions to try to generate images with visual consistency. These multiple executions consume significant computing resources, including processor cycles, memory usage, and network bandwidth. This results in inefficient use of resources and increased computational costs, particularly in large-scale applications.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method to generate multiple, self-consistent images of a visual object. The computer-implemented method includes obtaining, by a computing system, a textual prompt that textually describes the visual object. The method also includes for each of one or more update iterations: processing, by the computing system, the textual prompt with a machine-learned image generation model to generate a plurality of synthetic images that depict the visual object; and training, by the computing system, the machine-learned image generation model on at least some of the plurality of synthetic images. The method also includes, after a final update iteration of the one or more update iterations, processing, by the computing system, the textual prompt with the machine-learned image generation model to generate a plurality of output images that depict the visual object. Other embodiments of this aspect include corresponding computer systems, apparatus, and computer programs recorded on one or more computer storage devices, each configured to perform the actions of the methods. Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example technique for generating images with improved consistency according to example embodiments of the present disclosure.

FIG. 2 depicts a graphical diagram of an example embedding space with clusters of embeddings according to example embodiments of the present disclosure.

FIG. 3 depicts a flowchart diagram of an example method to generate images with improved consistency according to example embodiments of the present disclosure.

FIG. 4 depicts a flowchart diagram of an example method to train an image generation model on selected synthetic images according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

The present disclosure provides systems and methods for generating self-consistent synthetic imagery based on a textual prompt. The proposed approaches address the challenge of producing consistent character images across different contexts, which is a common limitation of existing text-to-image generative models. The proposed approaches can be beneficial in various creative fields such as book illustration, brand crafting, comic creation, presentation development, and webpage design, where visual consistency is crucial.

Previous techniques typically depend on multiple pre-existing images of the target character or involve labor-intensive manual processes. These methods often struggle with generating a consistent identity for the character, especially when the character is novel or imaginary. Moreover, these techniques may not generalize well to new characters as they are often trained on specific datasets.

The present disclosure, however, offers a fully automated solution for consistent character generation with the sole input being a text prompt. Some example implementations iteratively customize a pre-trained text-to-image model, using sets of images generated by the model itself as training data. The generated images can then be clustered based on their visual cohesion, and the model can be trained on these selected images. This process can be repeated until a model convergence metric is satisfied, resulting in a more consistent identity for the character.

One of the key advantages of this method is that it does not require any pre-existing images of the character, allowing for the generation of consistent and diverse images of the same character based solely on a text description. This makes the method highly versatile and applicable to a wide range of characters and contexts. Furthermore, the method is fully automated and domain-agnostic, eliminating the need for manual interventions or ad hoc solutions.

In summary, the present disclosure provides a practical and efficient approach to consistent character generation, which can greatly enhance the quality and consistency of generated visual content, thereby expanding the potential for visual creativity.

More particularly, one example aspect of the present disclosure is directed to a computer-implemented method to create self-consistent synthetic imagery. This method can be used to generate a variety of synthetic images that visually represent a specific object, which is described by a textual prompt. For example, if the textual prompt describes a “red apple with a yellow hat,” the system can generate multiple synthetic images of red apples with yellow hats. The images are created through the use of a machine-learned image generation model, which is trained and updated through multiple iterations to improve the quality and consistency of the generated images.

The process of generating synthetic images can involve multiple update iterations. In each iteration, the computing system can process the textual prompt with the machine-learned image generation model to generate a set of synthetic images. For instance, in the first iteration, the system might generate a set of images that resemble different red apples wearing different yellow hats. In subsequent iterations, the system can generate images that are more visually consistent. For example, the images can depict the same red apple wearing the same yellow hat.

Training of the machine-learned image generation model can be performed on at least some of the synthetic images produced during each iteration. This training can involve selecting a subset of the synthetic images that exhibit visual cohesion. For example, at each update iteration, if the system generates a hundred images of red apples wearing yellow hats, it might select the twenty images that most closely resemble each other for training purposes. This process ensures that the model is trained on the most representative and consistent images, improving its ability to generate visually consistent and coherent synthetic images in the future.

The selection of a subset of synthetic images for training can be based on the visual cohesion of the images. This cohesion can be assessed by generating embeddings for each image in a latent embedding space, clustering these embeddings, and evaluating a cohesion measure for each cluster. For instance, the system might group the images into clusters based on their visual similarities, then select the cluster with the highest cohesion measure for training. This process can help the system identify and focus on the most visually-consistent images.

In some implementations, the cohesion measure used to evaluate each cluster can be an average Euclidean distance between the members of the cluster and the centroid of the cluster. This measure allows the system to quantify the visual similarity of the images within each cluster. For example, a cluster with a small average Euclidean distance would contain images that are very similar to each other, indicating a high level of visual cohesion.

In some implementations, the computing system can also discard any cluster with a number of members below a certain threshold value. This process can help ensure that the system is training the model on a sufficiently large and representative set of images. For instance, if a cluster contains only two or three images, the system might discard it on the grounds that it does not provide enough data for effective training.

In some implementations, the process of clustering the embeddings can be performed using a K-MEANS++ algorithm. This algorithm provides high efficiency and effectiveness. In this context, it can be used to group the image embeddings into distinct clusters based on their visual similarities, facilitating the selection of a subset of images for training.

The training of the machine-learned image generation model on the synthetic images can involve several techniques. One such technique is a text-to-image personalization technique, which can help the system adapt the model to generate images that closely match the textual prompt. One text-to-image personalization technique is textual inversion, which can be used to learn a set of dedicated learnable textual tokens. These tokens can help the system better understand and interpret the textual prompt, improving the accuracy of the generated images.

The training of the model can also involve updating one or more parameters of the model itself. For instance, the system might adjust the weights of the model based on the training data, improving its ability to generate visually consistent synthetic images. As one example, this update can involve learning a set of low-rank adaptation values, which can help the system fine-tune the model for better performance.

The proposed approach represents a technical solution to a technical problem encountered in the field of generative models, particularly those converting textual prompts into visual imagery. The technical problem addressed by the present invention is the challenge of generating consistent and self-cohesive synthetic imagery based on a textual prompt. Previous techniques often struggle with maintaining a consistent identity for a character or object across different images, particularly when the character or object is novel or imaginary. Additionally, these techniques often require at least one pre-existing image of the character or object and require multiple to work effectively, and such images may not always be available. In contrast, the proposed techniques can generate visually consistent imagery of a novel object or character based only on an initial text prompt, without any images.

The proposed approach solves this technical problem by providing a fully automated method for consistent character generation, with the sole input being a text prompt. The system iteratively customizes a pre-trained text-to-image model, using sets of images generated by the model itself as training data. The generated images are then clustered based on their visual cohesion, and the model is trained on these selected images. This process is repeated until a model convergence metric is satisfied, resulting in a more consistent identity for the character. This method, therefore, represents a technical solution to the problem of generating consistent imagery that accurately represents a textual prompt.

Another technical problem addressed by the present invention is the inefficiency and high computational costs associated with the multiple redundant image generation model executions needed to generate images with visual consistency. The present method addresses this problem by automating the process of generating consistent images, thereby reducing the need for multiple executions. This results in a more efficient use of computing resources, thereby reducing computational costs.

Furthermore, the proposed method is domain-agnostic and does not require any pre-existing images of the character, making it highly versatile and applicable to a wide range of characters and contexts. This represents a technical solution to the generalization problem often faced in the field of text-to-image generative models.

Overall, the present invention provides a practical and efficient technical solution to the technical problems of consistency, efficiency, and generalization in the generation of synthetic imagery from textual prompts.

With reference now to the Figures, example embodiments of the present disclosure will be discussed in further detail.

### Example Techniques for Improved Visual Consistency

Example systems and methods described herein enable the generation of consistent images of a character (or another kind of visual subject) based on a textual description. This can be achieved by iteratively customizing a pre-trained text-to-image model, using sets of images generated by the model itself as training data. The model's output is funneled into a consistent identity, refining the representation of the target character. Once the process has converged, the resulting model can be utilized to generate consistent images of the target character in novel contexts.

Formally, an example computing system can obtain a text-to-image model M_{θ}, parameterized by Θ, and a text prompt p that describes a target character. In some implementations, the parameters Θ can include a set of model weights θ and an (initially empty) set of custom text embeddings τ. The proposed approach can result in a representation Θ(p) such that the parameterized model M_{θ(p)} can generate consistent images of the character described by p in novel contexts.

The approach taken in example implementations is based on the premise that a sufficiently large set of images generated by the model for the same text prompt, but with different seeds, will reflect the non-uniform density of the manifold of generated images. Specifically, some groups of images with shared characteristics are expected to be found. The “common ground” among the images in one of these groups can be utilized to refine the representation Θ(p) to better capture and fit the target. The method proposed involves iteratively clustering the generated images, and using the most cohesive cluster to refine Θ(p). This process can be repeated until convergence.

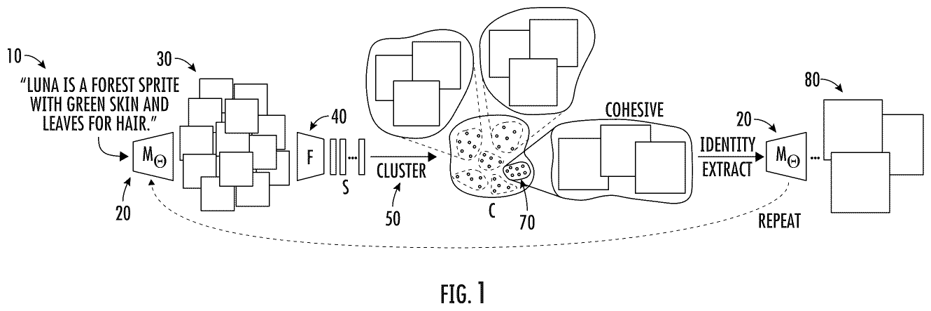

In particular, referring to FIG. 1, the process begins with an input text prompt 10. The input text prompt 10 can be any type of text description provided by a user or another source. This text prompt is used to describe the character or object which is to be visually represented in the generated images.

The input text prompt 10 is processed by the text-to-image model M_{θ} 20. The model M_{θ} 20, parameterized by Θ, generates a set of N images 30. These images are generated based on the description provided by the input text prompt 10 and are intended to visually represent the character or object described in the prompt.

Subsequent to the generation of the set of N images 30, each image is embedded in a high-dimensional semantic embedding space by a feature extractor F 40 (e.g., S=U_{N}F (M_{θ}(p))). The feature extractor F 40 processes each image and generates an embedding for each image in the embedding space. These embeddings represent the visual content of the images in a format that can be processed by the subsequent steps of the method. In example implementations, DINOv2 can be utilized as the feature extractor F.

Following the generation of the embeddings, the embeddings can be clustered using a clustering algorithm 50. As one example, the clustering algorithm 50 can be the K-MEANS++ algorithm. The algorithm 50 groups the embeddings into distinct clusters based on their visual similarities. Each cluster represents a group of images that share similar visual characteristics.

As one example, the K-MEANS++ algorithm can be employed to cluster the embeddings of the generated images according to Euclidean distances in the embedding space. The resulting collection of clusters C can be filtered by removing all clusters whose size is below a pre-defined threshold d_{min-c}.

The clusters are then evaluated by a cohesion measure. As one example, the cohesion measure can evaluate the average Euclidean distance between the members of a cluster c and the centroid c_{cen} of the cluster c:

$$cohesion ( c ) = \frac{1}{\vert c \vert} {\sum }_{e ∈ c} {‖ e - {c}_{cen} ‖}^{2} .$$

This measure can be used to assess the visual cohesion of the images within each cluster. The most cohesive cluster among the remaining clusters can be chosen to serve as the input for an identity extraction (re-training) stage.

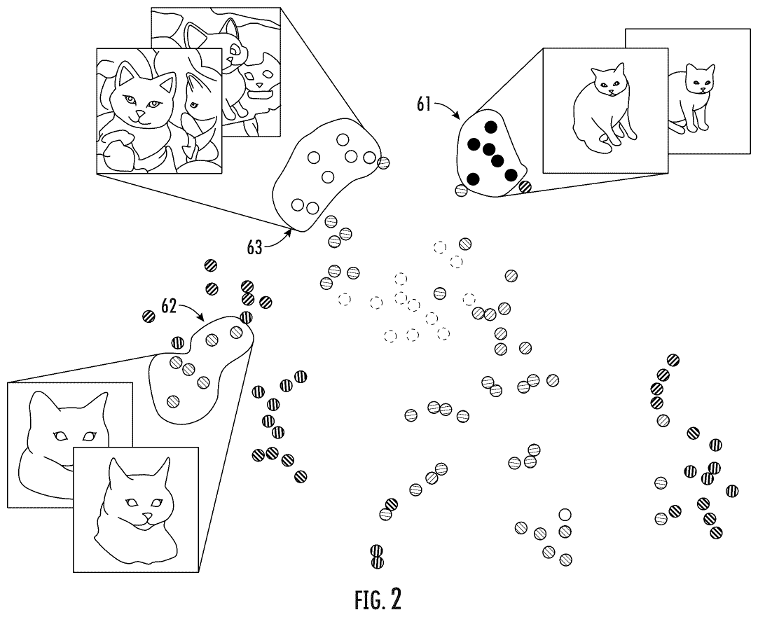

As one example, FIG. 2 illustrates a visual representation of the high-dimensional embeddings projected into a 2D space using t-SNE, an algorithm for dimensionality reduction that is well-suited for the visualization of high-dimensional datasets. Representative images are provided for three of these clusters to illustrate the characteristics shared by the images within each cluster.

For instance, cluster 61 represents a group of images that depict full-body representations of a cat character. These images share a common characteristic of providing a comprehensive view of the character's full body. Cluster 62, on the other hand, contains images that focus primarily on the cat character's facial features. These images typically provide a close-up view of the character's face, highlighting features such as the eyes, nose, mouth, and facial expressions. Finally, cluster 63 consists of images that depict multiple different cat characters.

The cohesion measure described earlier can be utilized to determine the most cohesive cluster among these three. For example, a cluster with a smaller average Euclidean distance between the members and its centroid is deemed more cohesive. In other words, the images within this cluster are more similar to each other, and therefore provide a more consistent representation of the character.

In the example illustrated in FIG. 2, cluster 61 is deemed the most cohesive, and is therefore chosen for the identity extraction or refinement stage. This means that the images within cluster 61 can be used to train the machine-learned image generation model and refine the model parameters Θ.

In particular, referring again to FIG. 1, after generating the clusters of the images, the system then selects the most cohesive cluster 70 for further processing. This cluster is chosen based on the cohesion measure, with the cluster having the highest cohesion measure being selected. The images within this cluster are used to train the text-to-image model M_{θ} 20 in the subsequent iterations.

More particularly, depending on the diversity of the image set generated in the current iteration, the most cohesive cluster c_{cohesive} may still exhibit an inconsistent identity. The representation Θ is therefore not yet ready for consistent generation, and it is further refined by training on the images in c_{cohesive} to extract a more consistent identity. This refinement can be performed using text-to-image personalization methods which aim to extract a character from a given set of several images that already depict a consistent identity. Despite the fact that these images are not completely consistent, their semantic similarity enables these methods to distill a common identity from them.

As one example, the text-to-image model M_{θ} 20 can be implemented as a pre-trained Stable Diffusion XL (SDXL) model, which utilizes two text encoders: CLIP and OpenCLIP. Textual inversion can be performed to add a new pair of textual tokens t, one for each of the two text encoders. However, this parameter space might not be expressive enough, hence the model weights θ can also be updated, for example via a low-rank adaptation (LoRA) of the self- and cross-attention layers of the model.

In some implementations, the standard denoising loss equation can be employed in the refinement process,

$${ℒ}_{rec} = {𝔼}_{x ∼ c , z ∼ E ( x ) , ϵ ∼ N ( 0 , 1 ) , t} [ {‖ ϵ - {ϵ}_{Θ ( p )} ( {z}_{t} , t ) ‖}_{2}^{2} ]$$

where c is the chosen cluster, E(x) is the VAE encoder of SDXL, ∈ is the sample's noise and t is the time step, zₜ is the latent z noised to time step t. The optimization of [symbol] _{rec} can be performed over Θ=(θ, τ), the union of the LoRA weights and the newly-added textual tokens.

Referring still to FIG. 1, the illustrated process can be repeated iteratively, with each iteration involving the generation of a new set of images 30, the extraction of features 40, the clustering of the embeddings 50, the evaluation of the cohesion measure, and the selection of the most cohesive cluster 70. This iterative process continues until a model convergence metric is satisfied.

Thus, as one example, the representation Θ extracted in each iteration can be used to generate the set of N images for the next iteration, thus funneling the generated images into a consistent identity. A convergence criterion can be applied for early stopping instead of using a fixed number of iterations. For example, after each iteration, the average pairwise Euclidean distance between all N embeddings of the newly-generated images is calculated, and the process stops when this distance is smaller than a pre-defined threshold d_{converge}.

Once the model convergence metric is satisfied, the final representation Θ is used to generate a set of consistent images 80. These images visually represent the character or object described in the input text prompt 10 in a visually consistent manner.

### Example Methods

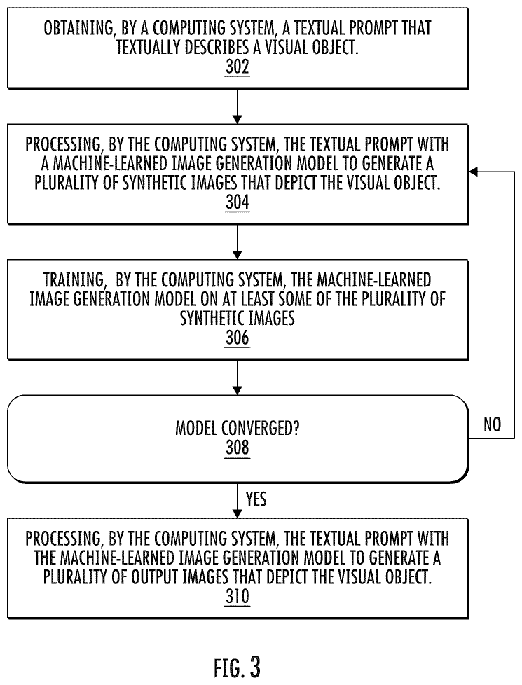

FIG. 3 is a flowchart that outlines an example method for generating self-consistent synthetic imagery based on a textual prompt. The process begins with step 302, where a computing system obtains a textual prompt that textually describes a visual object. This prompt serves as the basis for generating synthetic images that visually represent the object described in the textual prompt.

As one example, the textual prompt can be manually entered by a user through a user interface, such as a text box on a webpage or an input field in a software application. Alternatively, the textual prompt can be automatically generated by the computing system based on certain predefined rules or algorithms.

The textual prompt can describe a wide range of visual objects. For example, it can describe a physical object, such as a “red apple wearing a yellow hat”. Furthermore, the textual prompt can describe a complex scene, such as “a pink panda wearing a raincoat standing on a busy city street with a hot dog vendor to the right of the apple”. The flexibility of the textual prompt allows the system to generate a wide variety of synthetic images.

The computing system can obtain the textual prompt in various formats. For instance, the textual prompt can be a simple string of text, such as “red apple wearing a yellow hat”. It can also be a more structured format, such as a JSON object or an XML document, which can include additional information about the visual object, such as its size, shape, color, texture, and position. This additional information can help the system generate more accurate and detailed synthetic images.

The computing system can also obtain the textual prompt from various sources. For example, the textual prompt can be obtained from a local file stored on the computing system, such as a text file or a database. The textual prompt can also be obtained from a remote source over a network, such as a web server or a cloud storage service.

The textual prompt can also include metadata that provides additional information about the visual object. For example, the metadata can include the source of the textual prompt, the date and time when the textual prompt was created, the author of the textual prompt, and/or the intended use of the synthetic images. This metadata can be used by the system to customize the image generation process, thereby improving the relevance and usefulness of the generated synthetic images.

Following step 302, the method enters a loop where one or more update iterations are carried out. In each update iteration, as shown in step 304, the computing system processes the textual prompt with a machine-learned image generation model to generate a plurality of synthetic images that depict the visual object. This involves interpreting the textual prompt and using the image generation model to create multiple synthetic images that represent the visual object in the prompt.

As examples, the machine-learned image generation model can be a convolutional neural network, a generative adversarial network, a denoising diffusion model, or any other type of machine learning model suitable for image generation tasks. These models can learn complex patterns and features from the training data, allowing them to generate high-quality and realistic synthetic images. The choice of the model can depend on various factors, such as the complexity of the visual object, the quality of the training data, and the computational resources available.

Generating synthetic images at 304 can involve several steps. First, the computing system can process the textual prompt to extract relevant information about the visual object. This can involve natural language processing techniques, such as tokenization, stemming, and semantic analysis. The system can then use this information to guide the image generation process.

Next, the computing system can use the machine-learned image generation model to generate a set of synthetic images that depict the visual object. This can involve feeding the processed textual prompt into the model, and using the output of the model to generate the synthetic images. The number of synthetic images generated in each iteration can vary depending on the specific requirements of the application.

Next, in step 306, the computing system trains the machine-learned image generation model on at least some of the synthetic images generated in the previous step. This training process involves refining the model based on the generated images, allowing it to improve its ability to generate visually consistent and representative synthetic images in subsequent iterations.

The training process can involve various techniques to optimize the performance of the model. For example, the system can use gradient descent or its variants, such as stochastic gradient descent or mini-batch gradient descent, to minimize a loss function of the model such as, for example, a reconstruction loss. The system can also use optimization algorithms, such as Adam or RMSprop, to speed up the convergence of the training process.

The training process can also involve various regularization techniques to prevent overfitting and improve the generalization ability of the model. For example, the system can use dropout, where a fraction of the neurons in the model are randomly turned off during each training iteration. The system can also use weight decay, where a penalty term is added to the loss function of the model to discourage the weights from becoming too large.

In step 307, the computing system determines whether the model has converged. This can include evaluating a model convergence metric, which may be based on the visual consistency of the generated images. If the model has not yet converged, the process returns to step 304, and another update iteration is carried out.

Once the model has converged, the process proceeds to the step 308. In this step, the computing system processes the textual prompt with the machine-learned image generation model one more time to generate a plurality of output images that depict the visual object. These output images represent the final result of the process, providing a set of visually consistent synthetic images that represent the visual object described in the textual prompt with improved visual consistency.

The number of output images generated in this final processing can vary depending on the specific requirements of the application. For instance, if the application requires a single image, the computing system can generate one output image. On the other hand, if the application requires a set of images, the computing system can generate multiple output images.

The quality of the output images can also vary depending on the specific requirements of the application. For example, if the application requires high-resolution images, the computing system can generate output images with a high pixel count. Conversely, if the application requires images with a smaller file size, the computing system can generate output images with a lower pixel count.

In some implementations, the computing system can generate output images that include additional elements or features, apart from the visual object. For instance, the output images can include a background scene, other related objects, or textual annotations. These additional elements or features can enhance the visual appeal and informational value of the output images.

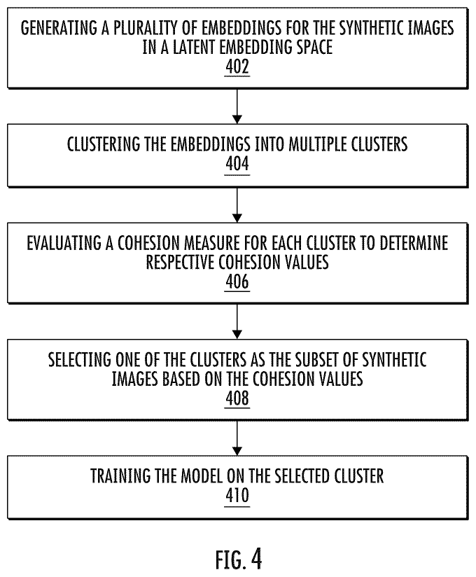

FIG. 4 is a flowchart of one example method for implementing step 306 of FIG. 3. In step 402, the computing system generates a plurality of embeddings for the synthetic images in a latent embedding space. This can include processing each synthetic image and creating an embedding for it in the latent embedding space. These embeddings represent the visual content of the images in a format that can be used for subsequent steps in the method.

As one example, the computing system can use a variety of machine learning models to generate the embeddings. These models can include, but are not limited to, convolutional neural networks, autoencoders, or any other type of deep learning model suitable for feature extraction tasks. The choice of the model can depend on various factors, such as the complexity of the synthetic images, the quality of the training data, and the computational resources available.

The embeddings can be generated in various dimensions, depending on the specific requirements of the application. For instance, the embeddings can be generated in a high-dimensional space, allowing for a detailed and nuanced representation of the synthetic images. Alternatively, the embeddings can be generated in a low-dimensional space, making them more manageable and computationally efficient.

The embeddings can also be generated using various types of data from the synthetic images. For example, the embeddings can be generated based on the pixel values of the synthetic images, capturing the visual characteristics of the images.

In step 404, the system clusters the embeddings into multiple groups or clusters. The clustering algorithm groups the image embeddings based on their visual similarities, resulting in clusters of images that share similar visual characteristics. This process can be implemented in a variety of ways, depending on the specific requirements of the application and the nature of the synthetic images.

One possible implementation involves using a K-means clustering algorithm. This algorithm partitions the embeddings into K clusters, where each embedding belongs to the cluster with the nearest mean. The K-means clustering algorithm provides simplicity and efficiency. However, it requires the number of clusters K to be specified in advance, which may not always be known or easy to determine.

Another possible implementation involves using a hierarchical clustering algorithm. This algorithm builds a hierarchy of clusters by successively merging or splitting existing clusters. The advantage of hierarchical clustering is that it does not require the number of clusters to be specified in advance.

Yet another possible implementation involves using a density-based clustering algorithm, such as DBSCAN. This algorithm groups together embeddings that are close to each other in the embedding space and have a sufficient number of neighbors. The advantage of DBSCAN is that it can discover clusters of arbitrary shape.

In some implementations, the computing system can use a combination of different clustering algorithms. For example, it can use K-means clustering for the initial partitioning of the embeddings, and then refine the clusters using hierarchical clustering. This can provide a balance between efficiency and accuracy.

Next, in step 406, the system evaluates a cohesion measure for each cluster to determine respective cohesion values. This measure quantifies the visual cohesion or consistency within each cluster. For instance, it can calculate the average Euclidean distance between the embeddings of the images within a cluster and the centroid of the cluster.

Thus, one possible implementation involves using an average Euclidean distance as the cohesion measure. In this case, the computing system can calculate the average Euclidean distance between each member of a cluster and the centroid of the cluster. This average distance can serve as the cohesion value for the cluster, with smaller distances indicating a higher level of cohesion. The advantage of using the average Euclidean distance is its simplicity and interpretability. Another possible implementation involves using a median Euclidean distance as the cohesion measure. This approach can be more robust to outliers compared to the average Euclidean distance.

Yet another possible implementation involves using a silhouette score as the cohesion measure. The silhouette score is a measure of how similar an object is to its own cluster compared to other clusters. It ranges from −1 to 1, with a higher score indicating a higher level of cohesion. The advantage of using the silhouette score is that it takes into account not only the cohesion within the cluster but also the separation between clusters.

In some implementations, the computing system can use a combination of different cohesion measures. For instance, it can calculate both the average distance and the silhouette score for each cluster, and combine them in some way to determine the cohesion value. This can provide a more comprehensive measure of cohesion, taking into account both the compactness of the cluster and its separation from other clusters.

In some implementations, the computing system can use a threshold value to determine whether a cluster is cohesive or not. For instance, it can consider a cluster as cohesive if its cohesion value is above a certain threshold. This threshold can be a fixed value, or it can be dynamically adjusted based on the characteristics of the synthetic images or the requirements of the application.

Next, in step 408, the system selects one of the clusters as the subset of synthetic images based on the cohesion values. As one example, the cluster with the highest cohesion value, indicating the most visually consistent images, is selected. The images within this selected cluster are then used for training the image generation model in the next iteration. This helps to refine the model and improve its ability to generate visually consistent images based on the textual prompt.

Thus, one possible implementation involves selecting the cluster with the highest cohesion value. In this case, the computing system can calculate the cohesion value for each cluster, and select the cluster with the highest value. This approach can ensure that the selected cluster exhibits a high level of visual cohesion, resulting in a more consistent and visually cohesive set of synthetic images.

Another possible implementation involves selecting the cluster that is closest to the centroid of the entire dataset. This approach can ensure that the selected cluster is representative of the entire dataset, resulting in a more balanced and representative subset of synthetic images. However, this approach may not always select the most visually cohesive or diverse subset of synthetic images.

In some implementations, the computing system can use a threshold value to determine whether a cluster is eligible for selection. For instance, it can consider a cluster as eligible if its cohesion value is above a certain threshold. This threshold can be a fixed value, or it can be dynamically adjusted based on the characteristics of the synthetic images or the requirements of the application.

In some implementations, the computing system can select multiple clusters instead of a single cluster. For instance, it can select the top N clusters with the highest cohesion values. This approach can provide a larger and more diverse subset of synthetic images, making it more suitable for applications that require a wide variety of synthetic images.

Finally, in step 410, the system trains the image generation model using the selected cluster(s) of synthetic images. For example, the training at 410 can be performed as described with respect to FIGS. 1 and 3.

### Example Devices and Systems

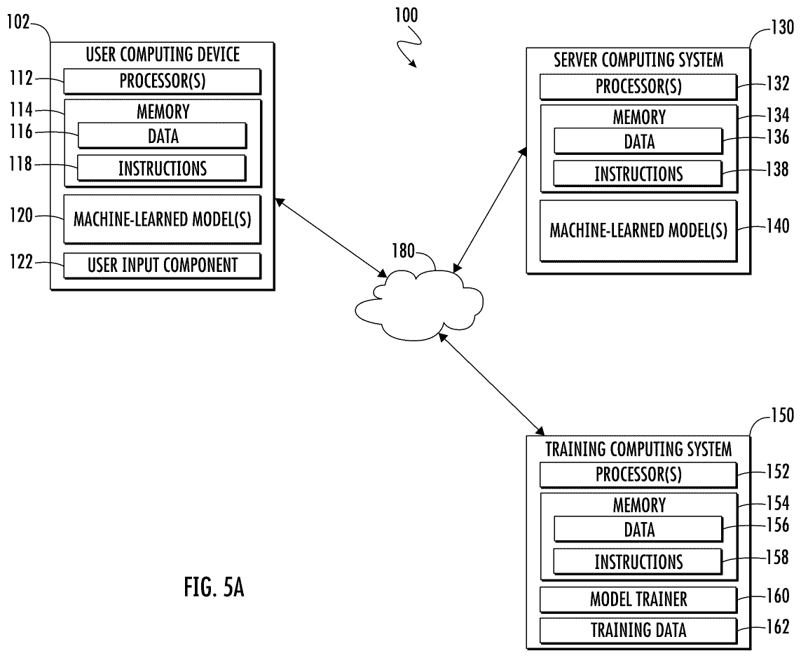

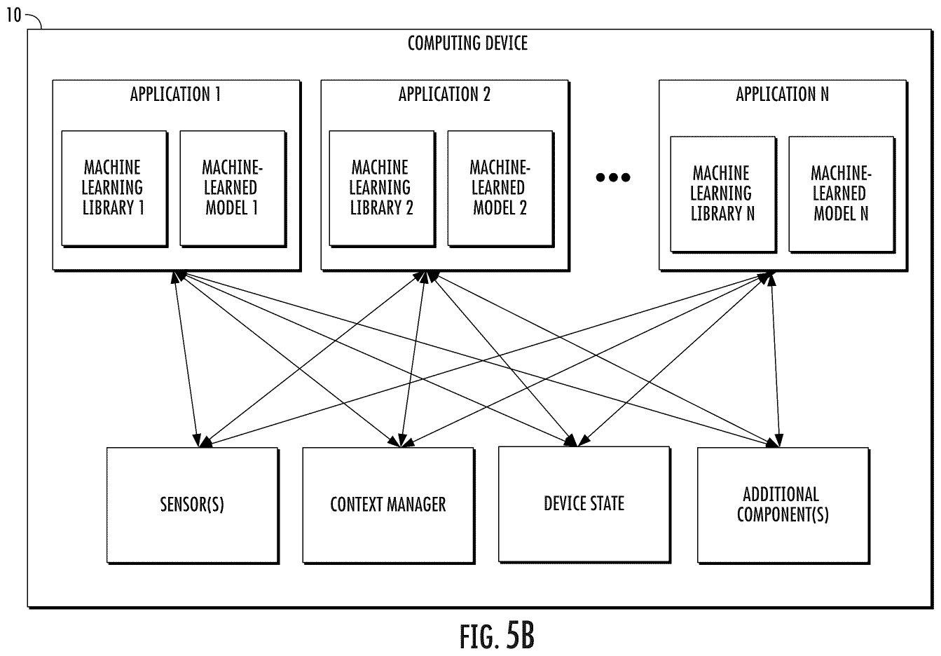

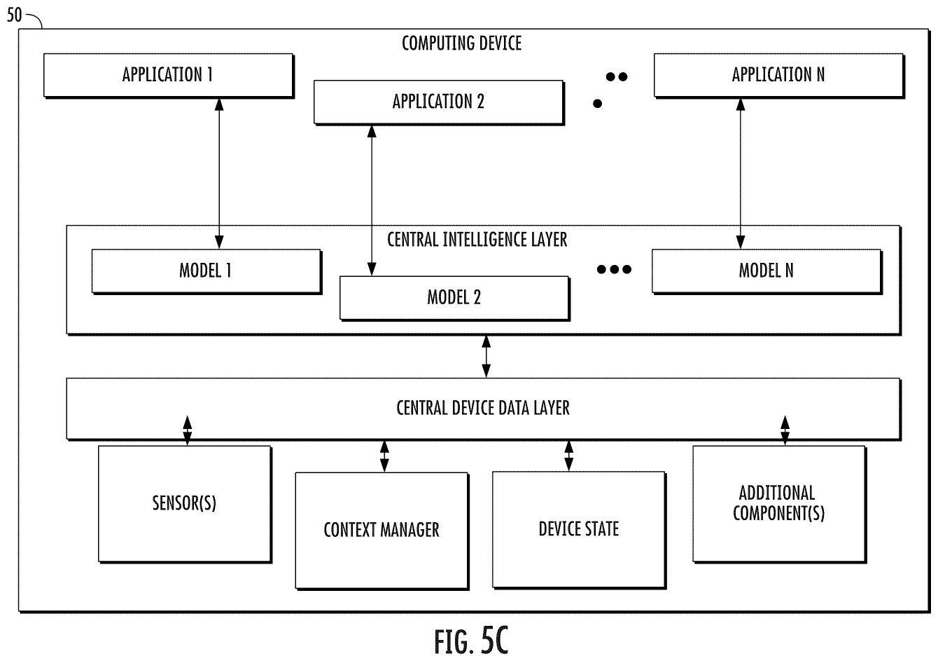

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to generate multiple, self-consistent synthetic images of a visual object, the method comprising:
obtaining, by a computing system, a textual prompt that textually describes the visual object;
for each of one or more update iterations:
processing, by the computing system, the textual prompt with a machine-learned image generation model to generate a plurality of synthetic images that depict the visual object; and
training, by the computing system, the machine-learned image generation model on at least some of the plurality of synthetic images; and
after a final update iteration of the one or more update iterations, processing, by the computing system, the textual prompt with the machine-learned image generation model to generate a plurality of output images that depict the visual object.

2. The computer-implemented method of claim 1, wherein training, by the computing system, the machine-learned image generation model on at least some of the plurality of synthetic images comprises:
selecting, by the computing system, a subset of the plurality of synthetic images that exhibit visual cohesion; and
training, by the computing system, the machine-learned image generation model on the selected a subset of the plurality of synthetic images that exhibit visual cohesion.

3. The computer-implemented method of claim 2, wherein selecting, by the computing system, the subset of the plurality of synthetic images that exhibit visual cohesion comprises:
generating, by the computing system, a plurality of embeddings respectively for the plurality of synthetic images in a latent embedding space;
clustering, by the computing system, the plurality of embeddings into a plurality of clusters;
evaluating, by the computing system, a cohesion measure for each of the plurality of clusters to determine a plurality of cohesion values respectively for the plurality of clusters; and
selecting, by the computing system, one of the plurality of clusters as the subset of the plurality of synthetic images based on the plurality of cohesion values.

4. The computer-implemented method of claim 3, wherein the cohesion measure evaluated for each cluster comprises an average Euclidean distance between members of the cluster and a centroid of the cluster.

5. The computer-implemented method of claim 3, further comprising discarding, by the computing system, any cluster with a number of members below a threshold value.

6. The computer-implemented method of claim 3, wherein clustering, by the computing system, the plurality of embeddings into the plurality of clusters comprises performing a K-MEANS++ algorithm.

7. The computer-implemented method of claim 1, wherein training, by the computing system, the machine-learned image generation model on at least some of the plurality of synthetic images comprises performing a text-to-image personalization technique on at least some of the plurality of synthetic images.

8. The computer-implemented method of claim 1, wherein training, by the computing system, the machine-learned image generation model on at least some of the plurality of synthetic images comprises performing textual inversion to learn a set of dedicated learnable textual tokens.

9. The computer-implemented method of claim 1, wherein training, by the computing system, the machine-learned image generation model on at least some of the plurality of synthetic images comprises updating one or more parameters of the machine-learned image generation model.

10. The computer-implemented method of claim 9, wherein updating the one or more parameters of the machine-learned image generation model comprises learning a set of low-rank adaptation values.

11. The computer-implemented method of claim 1, wherein the one or more update iterations comprise a plurality of update iterations.

12. The computer-implemented method of claim 11, wherein the method comprises performing update iterations until a model convergence metric is satisfied, wherein the model convergence metric comprises an average pairwise Euclidean distance between the synthetic images being smaller than a predefined threshold.

13. The computer-implemented method of claim 1, wherein the visual object comprises a novel visual object not depicted in any training data on which the machine-learned image generation model has been trained.

14. The computer-implemented method of claim 1, wherein the machine-learned image generation model comprises a pre-trained model.

15. The computer-implemented method of claim 1, wherein the machine-learned image generation model comprises a denoising diffusion model.

16. A computing system comprising one or more processors and one or more non-transitory computer-readable media that collectively store instructions that, when executed by the one or more processors, cause the computing system to perform operations, the operations comprising:
obtaining, by the computing system, a textual prompt that textually describes the visual object;
for each of one or more update iterations:
processing, by the computing system, the textual prompt with a machine-learned image generation model to generate a plurality of synthetic images that depict the visual object; and
training, by the computing system, the machine-learned image generation model on at least some of the plurality of synthetic images; and
after a final update iteration of the one or more update iterations, processing, by the computing system, the textual prompt with the machine-learned image generation model to generate a plurality of output images that depict the visual object.

17. The computing system of claim 16, wherein training, by the computing system, the machine-learned image generation model on at least some of the plurality of synthetic images comprises:
selecting, by the computing system, a subset of the plurality of synthetic images that exhibit visual cohesion; and
training, by the computing system, the machine-learned image generation model on the selected a subset of the plurality of synthetic images that exhibit visual cohesion.

18. The computing system of claim 17, wherein selecting, by the computing system, the subset of the plurality of synthetic images that exhibit visual cohesion comprises:
generating, by the computing system, a plurality of embeddings respectively for the plurality of synthetic images in a latent embedding space;
clustering, by the computing system, the plurality of embeddings into a plurality of clusters;
evaluating, by the computing system, a cohesion measure for each of the plurality of clusters to determine a plurality of cohesion values respectively for the plurality of clusters; and
selecting, by the computing system, one of the plurality of clusters as the subset of the plurality of synthetic images based on the plurality of cohesion values.

19. The computing system of claim 18, wherein the cohesion measure evaluated for each cluster comprises an average Euclidean distance between members of the cluster and a centroid of the cluster.

20. A non-transitory computer-readable media storing a machine-learned image generation model configured to generate images via interaction with a computing system that performs operations, the operations comprising:
obtaining, by the computing system, a textual prompt that textually describes the visual object;
for each of one or more update iterations:
processing, by the computing system, the textual prompt with a machine-learned image generation model to generate a plurality of synthetic images that depict the visual object; and
training, by the computing system, the machine-learned image generation model on at least some of the plurality of synthetic images; and
after a final update iteration of the one or more update iterations, processing, by the computing system, the textual prompt with the machine-learned image generation model to generate a plurality of output images that depict the visual object.
